(19) United States
(12) Patent Application Publication
(10) Pub. No.: US 2019/0065728 A1
(43) Pub. Date: Feb. 28, 2019

(54) Systems and Methods for Accessing Contents

(71) Applicant: Chian Chiu Li, Fremont, CA (US)

(72) Inventor: Chian Chiu Li, Fremont, CA (US)

(21) Appl. No.: 16/171,356

(22) Filed: Oct. 25, 2018

Related U.S. Application Data
(62) Division of application No. 14/749,625, filed on Jun. 24, 2015.

(51) Int. Cl. G06F 21/36; G06F 21/31; G06F 3/0481; G06F 3/0488

(52) U.S. Cl. CPC G06F 21/36; G06F 21/31; G06F 3/0488; G06F 3/04817

(57) ABSTRACT

Systems and methods for accessing contents, application programs, or applications at electronic devices. In an aspect, when a user enters a password plus an element, selected contents are presented or a selected application is launched along with an unlocking or login process. In other aspects, a button is arranged for executing a selected application directly or accessing multiple applications. A user may make a button appear, disappear, or reappear on screen with simple acts.

### CROSS REFERENCE TO RELATED APPLICATION

This is a division of U.S. patent application Ser. No. 14/749,625, filed Jun. 24, 2015.

### BACKGROUND

### Field of Invention

This invention relates to providing access to contents or an application program, more particularly to providing access to selected contents or a selected application program at an electronic device.

### Description of Prior Art

Smartphones or smart phones have become a ubiquitous phenomenon in recent years. Its main usage has gone far beyond that of telephone. In fact, most times people use it for connecting with friends in social networks, checking and writing short messages and emails, getting news and info online, watching video, playing games, and so on. Functionalities of smartphone are enabled by application programs, also known as applications or apps, which may be pre-installed by a manufacturer at an assembly factory or downloaded and installed by a user later on. Since almost all functions a user may want to use need an enabling application, a smartphone may carry lots of them. To access an application, a user may go to a “desktop” screen or a home screen first, and then tap on the application's icon to activate it. As there may be many applications installed, several pages of icons may be arranged. Thus, it may take a couple of steps to access an application starting from returning to the home screen, which may become annoying when a user is in a hurry to see results.

On the other hand, in order to conserve battery power and avoid accidental or unauthorized access, a phone is often locked or logged out automatically after a short period of inactivity. A locked or logged out state is usually an idle or standby mode with a dark screen. A lock state may require a password, pass code or personal identification number (PIN) to get unlocked. In such a case, a user may have to enter a password to unlock a phone, before performing other steps to invoke a target application. As a consequence, a locked screen adds additional steps for launching an application.

Cumbersome processes to access contents are also found with other devices, such as tablet computer, laptop computer, desktop computer, etc. Contents as used here may include a variety of information such as pictures, literature, web pages, news, music, video clips, local or remote data or file folder, etc. Many contents may need a program custom made for presentation on a display screen. Currently, switching from doing one to another program may involve getting back to a desktop page. For instance, when a user is surfing on the Internet, he or she has to return to the interface of desktop before looking for another program. Thus, accessing a program or contents may also be inconvenient with devices other than smartphones.

Accordingly, there exists a need to provide easy and convenient access to application/program and contents on smartphones and other electronic devices.

“Icon” or “button” is used as a graphic identifier on a device screen and the two may be treated equally in the following discussions. “Icon” or “button” may be associated with an application, a computer file, or certain contents of computer information. They may show up as graphic objects on a screen and may be activated when a user taps on it using a fingertip or clicks on it using a computer mouse. Once an icon or button is activated, via tapping or clicking for instance, a corresponding application may be launched, a file may be opened, or certain contents may be presented. An icon or button on a screen provides an easy and convenient access to reach an application, a file, or certain data. Normally, when an icon or button is visible on screen, it means it is accessible and executable.

### Objects and Advantages

Accordingly, several main objects and advantages of the present invention are:
a). to provide an improved method and system for accessing applications or contents;
b). to provide such a method and system which arrange easy access to an application;
c). to provide such a method and system which arrange access to an application directly from a locked state via a password and an element;
d). to provide such a method and system which arrange access to an application via an express button;
e). to provide such a method and system which arrange access to multiple applications via an express button and button window; and
f). to provide such a method and system which enable an express button to appear or disappear in response to tapping, hovering, or shaking act.

Further objects and advantages will become apparent from a consideration of the drawings and ensuing description.

### SUMMARY

In accordance with the present invention, methods and systems are proposed to provide easy and convenient access to applications and contents. In one aspect, a selected application is directly invoked when a password entered contains a genuine password plus an extra item during an unlocking process. In another aspect, an express button is arranged for accessing a selected application or a list of selected applications. In yet another aspect, an express button appears, disappears, reappears, and disappears again in response to tapping, hovering, or shaking act.

### DRAWING FIGURES

FIG. 1 is an exemplary block diagram describing one embodiment in accordance with the present invention.

FIG. 2 is an exemplary flow diagram showing an embodiment involving password use in a locked state in accordance with the present invention.

FIGS. 3 and 4 are illustrative examples and diagrams showing embodiments involving password use in a locked state in accordance with the present invention.

FIGS. 5-A and 5-B are illustrative diagrams showing embodiments involving an express button in an unlocked state in accordance with the present invention.

FIGS. 6-A and 6-B are exemplary diagrams showing reemergence of an express button or appearance of a button window in accordance with the present invention.

FIG. 7 shows an exemplary diagram to depict a button window having multiple icons in accordance with the present invention.

FIGS. 8-A and 8-B are exemplary diagrams showing reemergence of an express button or appearance of a button window in accordance with the present invention.

### REFERENCE NUMERALS IN DRAWINGS

| 10 | Sensor | 12 | Database |
|---|---|---|---|
| 14 | Communication Network | 16 | Processor |
| 18 | Processing Module | 20 | Sensor |
| 22 | Computer Readable Medium | | |
| 24 | Sensor | 26 | Home Button |
| 28 | Express Button | 30 | Smartphone |
| 32 | Button Window | 34 | Express Button |
| 36 | Express Button | 38 | Finger |
| 40 | Button Window | 42 | Express Button |
| 44 | Express Button | 46 | Button Window |
| 80 | Client System | 82 | Service Facility |

100, 102, 104, 106, 108, 110, 112, and 114 are
exemplary steps.

### DETAILED DESCRIPTION

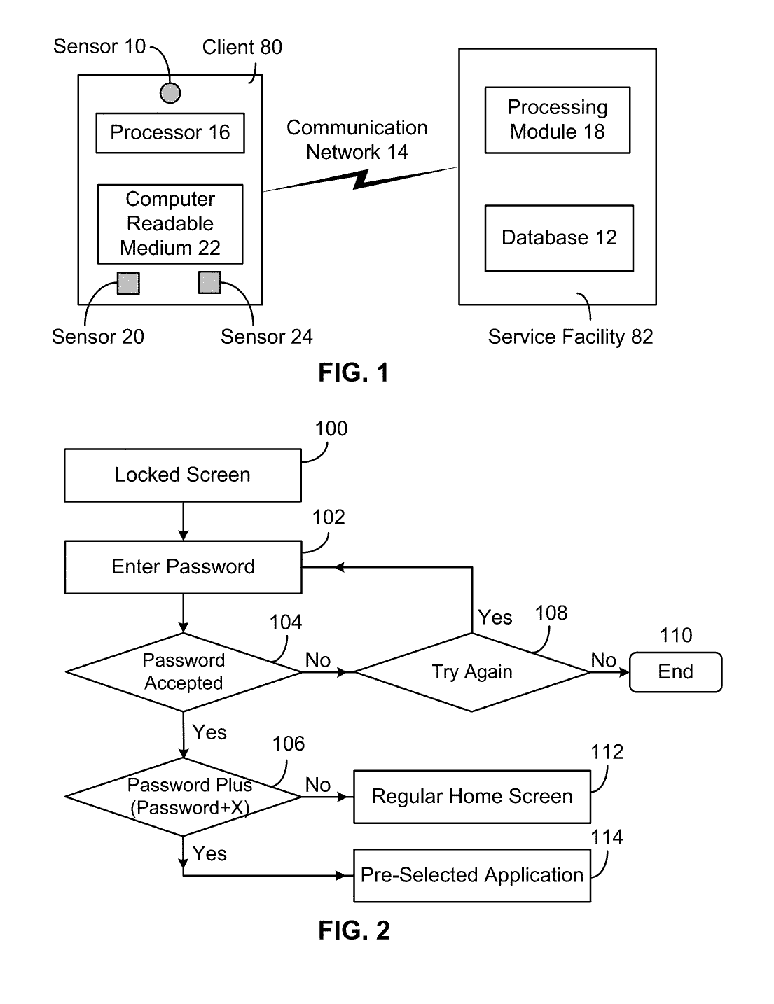

FIG. 1 is an exemplary block diagram of one embodiment according to the present invention. A client system 80 and service facility 82 are connected via a communication network 14. Client 80 may represent an electronic device, including but not limited to smart phone, smart watch, desktop computer, notebook computer, tablet computer, other wearable devices, and the like. Client 80 may include a processor 16 and computer readable medium 22. Processor 16 may mean one or more processor chips or systems. Medium 22 may include a memory hierarchy built by one or more memory chips or storage modules like RAM, ROM, FLASH, magnetic, optical and/or thermal storage devices. Processor 16 may run application programs or sets of executable instructions stored in medium 22 for performing various functions and tasks, e.g., tending to social networks, playing games, playing music or video, surfing on the Internet, email and message receiving and transmitting, taking picture or video clips, logging in a secured account, disarming a security system, etc. Client 80 may also include input, output, and communication components, which may be individual modules or integrated with processor 16. Usually, client 80 may have a display (not shown in FIG. 1 for brevity reasons) with a graphical user interface (GUI). The surface of a display screen may be made sensitive to touches, i.e., sensitive to haptic and/or tactile contact with a user, especially in the cases of tablet computer, smartphone, smart watch, and other wearable devices. A touch screen may be utilized to implement on-screen icons, virtual or soft buttons and/or a virtual or soft keyboard, like used widely on most smart phones, smart watches, and tablet computers. Client 80 may also have a microphone and a voice recognition component (both not shown in FIG. 1 for brevity reasons) to receive verbal input from a user.

Service facility 82 may include a processing module 18 and database 12. Module 18 may contain one or more servers and storage devices to receive, send, store and process related data and information.

The word “server” means a system or systems which may have similar functions and capacities as one or more servers. Main components of a server may include one or more processors, which control and process data and information by executing software, logic, code, or carrying out any other suitable functions. A server, as a computing device, may include any hardware, firmware, software, or a combination. In the most compact form, a server may be built on a single processor chip. In the figure, module 18 may contain one or more server entities that collect, process, maintain, and/or manage information and documents, perform computing and communication functions, interact with users, host social networks, deliver information required by users or arranged by schedules, etc. Database 12 may be used to store information and data related to users, the facility, and service providers who use the facility. The database may include aforementioned memory chips and/or storage modules.

A communication network 14 may cover a range of entities such as the Internet or the World Wide Web, a local area network (LAN), a wide area network (WAN), a metropolitan area network (MAN), a telephone network, an intranet, wireless, and other types of networks. Client 80 and facility 82 may be connected to network 14 by various wired, wireless, optical, or other connections.

Client 80 may include an optical sensor 10 which tracks the eye of a user using mature eye-tracking technologies. For some smartphones and tablet computers, sensor 10 may be a regular front-facing camera module used to take pictures by a user in daily life. The sensor may be arranged very close to the screen of a display and to sense the facial part of a user. The system may recognize whether a user gazes at the display screen of client 80. In a more advanced mode, sensor 10 may be used to determine where a user is looking at among places on a screen, such as the top, bottom, left edge, right edge, or a particular area of the screen. Sensor 10 may be built using imaging technologies, and the image of eye may be analyzed to decide which direction a user is looking at through algorithms. Both visible and infrared light may be employed for eye-tracking purpose. In the latter case, infrared light source may be arranged to provide a probing beam.

Client 80 may also include a proximity sensor 20 to detect whether a device is close to human body or held in hand. Proximity sensing technologies are well known in the art and many smartphones have such a sensing function already. Related technologies include infrared, capacitive, inductive, or other suitable schemes.

Furthermore, client 80 may contain a motion sensor 24 to detect its own movement by sensing acceleration, deceleration, and rotation. Sensor 24 may employ one or multiple accelerometers, gyroscopes, and/or a pressure sensor for performing various measurement tasks which may include detecting device shaking, device vibration, device moving of other kinds, and so on. These measurements help detect conditions and the environment of a user or a device. They also make it possible to use shaking, knocking, waving, or other manners to convey user instructions. Knocking may mean repeated gentle hits at a device body or screen. Knock may be applied by finger, fingertip, or any object which can cause a hit on a device. Knock is preferred to aim at a non-interactive area of a device or at a place where a knocking act doesn't have unwanted consequences for a corresponding application program at a device. It is obvious that patting a device using a hand or finger is another kind of knocking. For simplicity reasons, only knocking is mentioned in the following discussions, although both knocking and patting may produce the same effect and generate the same user commands.

Inside client 80, output signals of sensors may be transmitted to processor 16, which, employed with certain algorithms, may process the data and act according to predefined programs. For instance, processor 16 may process data transmitted from sensor 24, extract device motion info, and then convert the info into user instructions. If the info is interpreted as commands to show an on-screen icon, processor 16 may generate instructions to make the icon visible.

FIG. 2 shows exemplarily a schematic flow diagram illustrating one embodiment according to the present invention. The essence of this embodiment is to utilize a password and enable a password submission process to have additional functions. In practice, many smartphones and workplace computers are configured to automatically lock themselves after a given amount of idle time elapses. Unlocking a device with a dark or screen-savor display typically requires a user to press a specific button, such as a home button on the housing of a smartphone, or any key of a computer keyboard. Then a locked screen may be lightened and show up. Next, the user may be prompted to enter a password or PIN.

Returning to FIG. 2. Step 100 starts from a locked screen of a device. In step 102, a user enters a password. In a conventional case, there is only one right answer. If the password entry is correct, a home screen or desktop setting shows up, or a screen configuration existed before logout comes back. Next, the user has to spend time finding and activating an application. But in step 104, the rules are different. The question is not whether a password entry is correct, but whether it is accepted. If it is not accepted, the user may try it again via step 108; otherwise, an end comes in step 110. If it is accepted, there are two outcomes in step 106, instead of one. If the input is exactly a predefined password, nothing less and nothing more, a regular response kicks in. The device is unlocked and a home screen is presented in step 112. However, if the entry is of password plus, where a user enters a password plus another element, which forms a combination of password and something else, not only the device is unlocked, but also a pre-selected program is launched, as in step 114. Thus, compared to traditional methods, the embodiment invokes a specific program directly and automatically during or right after an unlocking process. Because the right answer may be a password plus anything, nothing shall be remembered except the password. Thus it doesn't create any memory hassle. On the other hand, the integrity of password is not affected, as it is built upon the original one and maintains the original password strength. Therefore, the proposed method doesn't incur any additional burden for user, nor does it undermine anything, but in the meantime provides direct, quick, and convenient access to an application of choice.

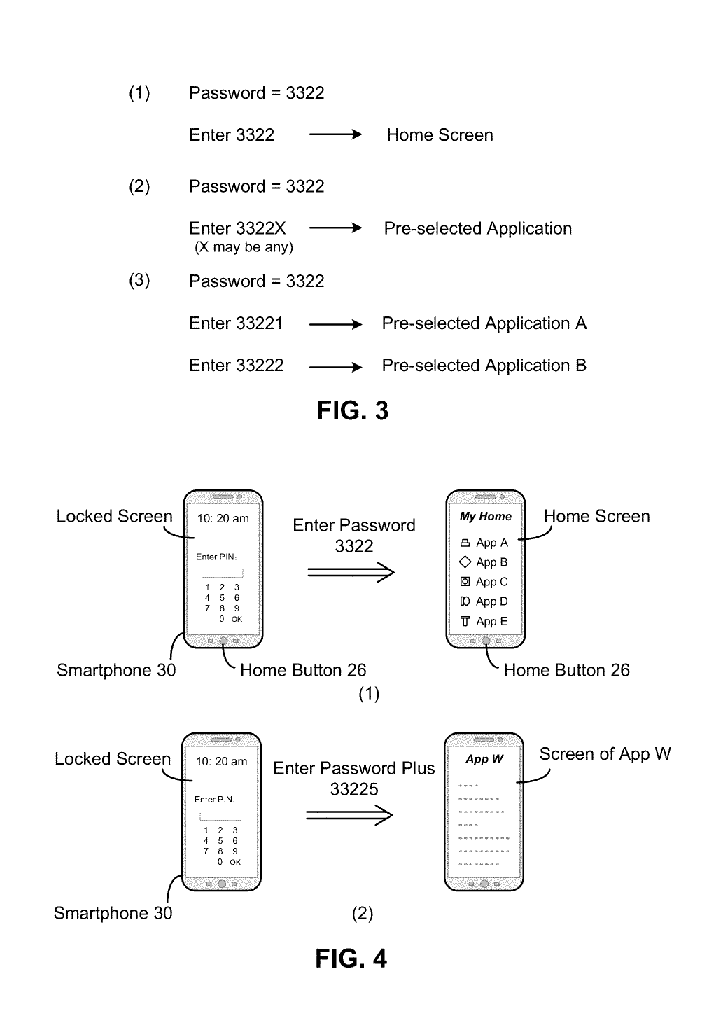

FIG. 3 shows schematic examples which utilize password input to access and execute an application at a device. Assume a locked screen is prepared. Case 1 represents a conventional scenario, where the password is arranged to be 3322 and the input is also 3322. The correct and exact password may prompt a home screen. In case 2, the password is still 3322, but the entry is 3322X, where X may be any number, letter, character, mark, or sign. Whether the password entry is 33221, 3322+, 3322777, or 3322X, the ensuing events are the same, i.e., device unlocking plus loading and executing a pre-selected application. In other words, it may be designed such that when the password entry equals to a password plus another item, a system may be unlocked and additionally, an application may be invoked. The application is pre-selected and may be changed to another program by a user. Case 2 introduces a simple and easy way to launch an application directly from a locked or logoff state. This method allows only one application for direct access. Since the extra item attached to a password can be of anything, it is easy for users to remember and use.

For some other users, however, it may be desirable to have more applications available for direct hit from a locked state. Case 3 depicts a method to satisfy such needs, where different elements may be arranged to invoke different applications respectively. Assume that the password is still set as 3322. When the system receives password entry of 33221 or 33222, where number 1 and 2 are the added elements, it may be configured to execute application A or application B respectively. Thus a user may be able to arrange a list of applications which may be invoked directly from a locked state using different suffixes. Furthermore, it may be designed such that a password plus X, XX, or XXX correspond to three applications, where X may be any letter, single digit number, or mark, as the system may be designed to take the quantity of element only and ignore what an element is. For example, assume the password is still 3322. Then entry of 33227, 332245, 3322668 may invoke three applications respectively. A system may also be designed to take prefix, instead of suffix, as the additional element for password entry. Examples of password plus prefix include 13322, X3322, or XX3322, where X may be of anything, assuming the password is still 3322.

FIG. 4 shows diagrams to illustrate the aforementioned embodiment graphically according to the present invention. A smartphone 30 is enlisted here and below as an electronic device for the purpose of describing principles. Assume the phone has a touch sensitive screen. In case 1, the phone is in a locked or logout state with a lock screen which shows time and a soft keyboard (only numerals are shown while possible alphabets are omitted for simplicity reasons). Most times a locked screen is dark, which may be lightened by pushing a home button 26 located close to the screen. Button 26 may be a hard button, also known as hardware tactile button which may be depressed physically for activation. Assume functionality of the home button when being activated includes lighting up a dark screen in a locked state, and resuming a home screen in an unlocked state. To unlock the screen, a password, e.g. 3322, is entered, and then a home screen appears, displaying icons of a group of applications. If a user wants to run an application on the home screen, he or she may tap a corresponding icon. If a desired app is not on the first page, the user has to turn to another page to find it. In case 2, the process of starting a specific app is simplified by password-plus method. Assume that a user enters password 3322 plus another element, say 33225, where digit 5 may be of any other number. Once the system detects that it is a combination of password and one element, it starts accessing App W as programed. Subsequently, App W is launched while the system is being unlocked, and a screen view of App W appears. Therefore, the password-plus method may save a couple of steps each time for a locked state. It may be particularly useful when a user frequently runs a program, such as checking emails, posts, or update on a hot event. The method applies to all password forms, such as passwords including a number, a letter, a sign, an image, and/or a pattern, and the extra element may include a number, a letter, a sign, an image, and/or a pattern too.

A password-plus method may also be used to log in an account and access certain contents directly. For instance, when a user logs in a bank account, via a service center like facility 82 of FIG. 1, it may be designed such that a password plus an element may cause opening of a selected web page, not just a typical account home page as arranged for everyone by a bank. Thus if a user checks the balance of savings account frequently, he or she may assign a web page of savings account as the chosen priority page. Then each time, when the user enters a password plus an extra item during a login process, a savings account page may show up right after a password is verified. Therefore no searching and page turning are needed after the login, and it saves time for users while providing efficiency and convenience. It may be designed such that a user has the freedom to choose or change a priority web page any time. To provide more choices for users, a login page may display a code & option list. For instance, a list posted may remind users that for checking account, add suffix “1” to a password; for savings account, add suffix “2”, for user profile, add “3”, etc. So a user doesn't need to memorize anything except own password. Once a suffix is submitted along with a password, a corresponding page is presented directly after a user logs in his or her account. For the convenience of some users, prefix may also be used, i.e., a code may be entered before password. Alternatively, a prefix or suffix element may be replaced by a statement or a selection represented by icon, button, or checkmark. For instance, three prefix buttons, “Checking Account”, “Savings Account”, and “User Profile” may be arranged beside a password entry area on a bank login page. It may be designed such that when a user taps, clicks or checks a prefix button first and then enters a password, a selected web page may be displayed after the login process is finished. Since the method is more straightforward and understandable, it may provide additional ease for users.

Moreover, a password-plus method may be used in a home or office security system. For instance, a security system may be designed such that when a password entry contains password plus a number 1, the system may be disarmed and additionally, lights and air conditioning system may be turned on right away. Thus not only the alarm system becomes off, but also a task is carried out because the system receives a password plus one extra element at a control panel. It may provide convenience for users. The task may be pre-scheduled, editable, and may contain complicated details. As tasks may not be confidential, they may be posted beside a control panel, like “1” for lights and air conditioning, “2” for lights only, “3” for air conditioning only, etc. When a user keys in password, he or she may take a look at a task list, and then add one extra code to do a selected extra job. Therefore, it doesn't create anything more to memorize, while more work may be done with ease.

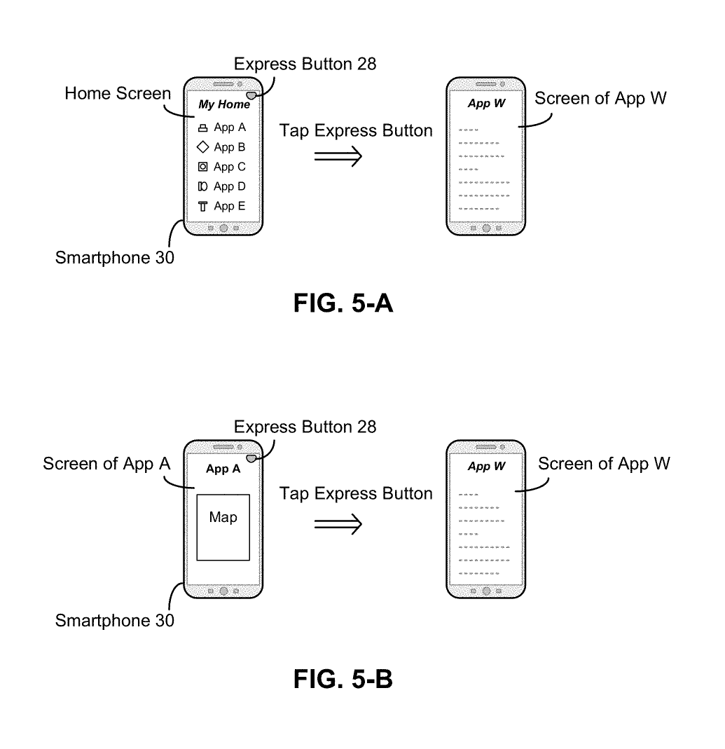

Another embodiment is shown schematically in FIGS. 5-A and 5-B according to the present invention. Assume that a device is in login or unlocked state and a user wants to access an application. With conventional methods, the user may return to the home screen to find a specific icon on the first page or go to another page, which may mean turning several pages and thus may become tedious. In FIG. 5-A, the home screen of smartphone 30 is configured with a soft express button 28. Button 28 works like a short cut of a selected application. For instance, App W may be associated with the button. Once button 28 is tapped or activated, App W may be launched. So an express button may be called priority button as well, since both names mean a quick passage to reach an application. With an express button, going from one page to another page to find an icon is no longer needed. Therefore it makes running a selected application direct, quick, and convenient.

Similarly in FIG. 5-B express button 28 is configured in a screen setting of App A. Assume that button 28 still represents App W. Traditionally in order to access App W, a user may have to return to the home screen to search for a target icon in a multi-step process. But as button 28 is arranged, tapping to activate it may be all needed to invoke the app.

It may be designed such that button 28 remains visible and at the same place when the smartphone screen shows contents of different programs. For instance, when the screen view changes from home screen of FIG. 5-A to the screen view as depicted in FIG. 5-B, button 28's position remains the same. In other words, an express button may be arranged visible regardless of applications shown on screen, or a selected application, like App W, may remain easily accessible as long as the phone is in an unlocked mode. For smartphone cases, as the screen size is limited, it may be appropriate for one or at most, two express buttons appearing on screen at the same time for some applications. It is a delicate issue, as existence of the express button may affect or disturb content presentation.

In addition, it is desirable that the property of an express button is configured editable and can be assigned to or associated with different applications. For instance, button 28 may be edited to represent a program other than App W. Furthermore, the size, shape, and color of an express button as shown on screen may be designed to be editable too.

Moreover, button 28 may represent a bookmark list for multiple apps which may be accessed individually. For instance, a user may tap button 28 to display an app list. Then the user may tap one app to invoke it. This method requires two taps, but provides easy and quick access to multiple applications. Application or a group of applications associated with an express button may be arranged and changed in login or unlocked state by a user. The button may be configured as a soft button on or around a screen or a hard button built close to a screen.

Since some users may find button 28 bothersome or even obtrusive in the screen view of App A in FIG. 5-B, the button may be designed such that when it is tapped or clicked, it is activated and App W is launched; and when a fingertip or computer cursor hovers over the button without tapping or clicking, the button is removed from the screen if a time period of hovering goes beyond a given value, say two or three seconds or less. It may also be designed such that, when a place, where a button disappears, is tapped or a fingertip or cursor hovers over the place for a given period of time, say two or three seconds or less, the button may reemerge. Therefore, an express button may remain on screen during running periods of different programs, and a user may be able to make a button disappear, appear, or reappear on screen any time when needed. The appearance and disappearance of an express button provide convenience and flexibility for users. When a user favors easiness to access an app, an express button may be brought on screen; when the button becomes unnecessary, finger hovering may cause it to go away; when the user changes mind and wants the button back, tapping or fingertip hovering may make it back on screen. Thus an express button may appear, disappear, or reappear as a user likes it to.

Whether or where a finger hovers over a touch-sensitive screen may be detected by mature proximity sensing technologies. Methods of proximity detection include measuring changes in capacitance above a screen surface or measuring disturbances in a small electromagnetic field above a screen surface.

On the home screen of a smartphone, multiple buttons and icons may be displayed. Thus, one extra item like express button may not cause any issue. But a foreign object in a screen view of other programs may become a sore spot. For instance, when photos and pictures are shown, they may take over the whole screen area. Obviously, any on-screen alien object like a button or an icon may disrupt the presentation and become unwelcome. Consequently, when certain contents are displayed, a screen may be used for it exclusively and no foreign objects would be allowed in the screen view.

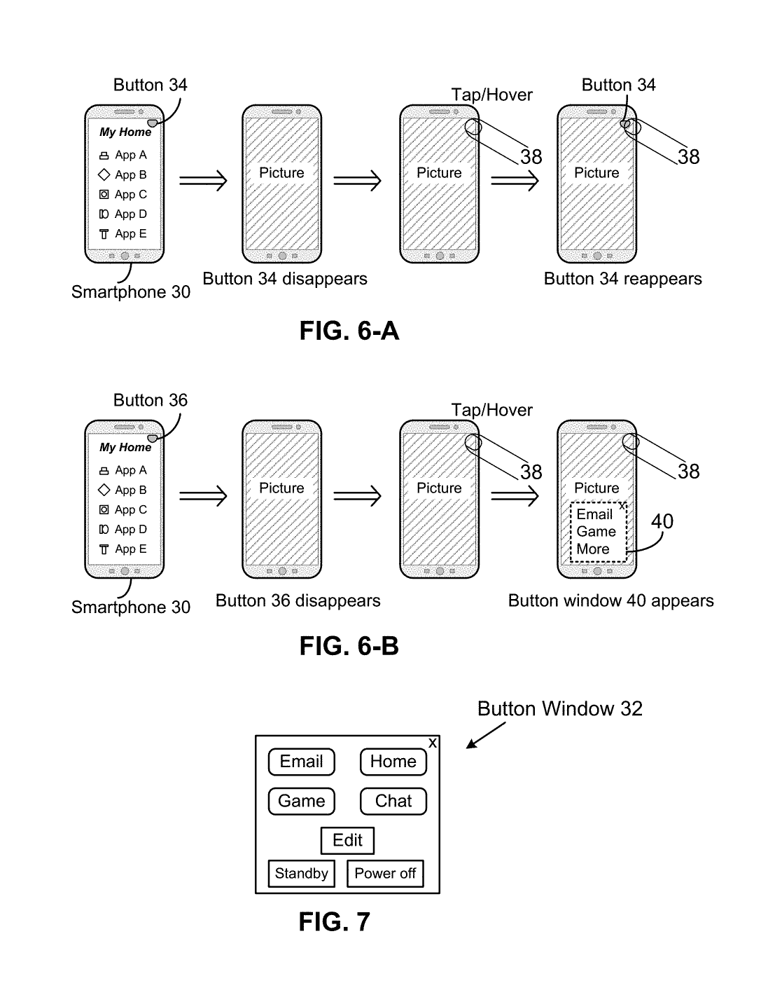

However, the need to easily access a special application still exists. To accommodate such a demand, embodiments are introduced in FIGS. 6-A and 6-B. In the schematic diagrams, smartphone 30 is again employed as an example client device. It starts from a home screen in FIG. 6-A, where icons of several applications are displayed. A button 34, as an express button for a selected application, is positioned at the right upper corner of the screen. Assume that the phone has a touch-sensitive screen. Once button 34 is activated by tapping, the selected application will be launched. Next assume a picture-viewing app is opened. In order to maintain the picture integrity and ensure good user experience, it may be designed such that only the contents of picture are presented. Thus, everything on the home screen, including button 34, is removed. When a user wants to access the selected app, he or she may return to the home screen and find it. But the system may be designed to make it easy to access a chosen application. For instance, a user may tap the place at the right upper corner using finger 38, where button 34 used to be, or let the tip of finger 38 hover over that place. It may be programed such that the tapping or hovering act makes button 34 reappear at the same place. In other words, when phone 30 detects tap or fingertip hovering signals, it takes it as user commands and display button 34 on screen accordingly. The reappearance of button 34 may last a short period of time, like two to five seconds. A user may tap the reemerged button to launch the selected application. The reappearing button provides easy and quick access. In case some users consider a reappearing button stays there for too long, certain mechanism may to be designed for a user to obscure the button anytime. For instance, it may be configured that a reappearing button may disappear again when a fingertip hovers over it beyond certain short time, say two seconds or less. If a hovering act is too much for some users, it may be designed such that tapping-button-once opens up an app, and tapping-button-twice makes it disappear. Therefore, a user may tap on certain spot to bring out an express button, tap the button once to launch an app, or tap it twice to remove it from screen. It is well known that tapping twice means two consecutive taps on a button within a short period of time, say less than one second.

Besides tapping or hovering, a user may also use voice-recognition technology to give commands to a device. For instance, a user may say “button” to make an express button appear temporarily while viewing contents like picture or video, say “hide” to make the button disappear, and say “execute” to activate it and launch an app.

Sometimes a user may have multiple preferred applications which need easy access. But it's impractical to arrange many express buttons on a screen, especially on a relatively small screen of a smartphone, smart watch, or wearable device. In fact, it may be proper to display only one or two express buttons on a small screen at a time, in order not to make a screen view crammed and unsightly.

FIG. 6-B shows exemplary diagrams of another embodiment which provides easy access to multiple applications. Assume smartphone 30 is with a home screen. There are icons of applications and an express button 36. It may be designed such that tapping button 36 causes display of a list of programs, providing easy access to multiple options. Next, a picture presentation app is launched and the whole screen is used for the show. Thus all contents including icons and buttons on the home screen become invisible. A user may enjoy the picture show without any distraction on screen. In the middle of the picture presentation, if the user would like to go to a selected application, he or she may tap the place where button 36 used to be on the home screen or make the tip of finger 38 hover above the place. Then a small window 40 may show up with a list of apps, like email, game, social network, etc. A user may choose an app and then tap on its icon to launch it. Window 40 may appear for a short period of time, like two to five seconds, and then close up by itself. A user may also close the window any time by tapping the “X” icon in the window. As a user's interest may change over time, contents of window 40 may be editable so that applications may be added, switched, or deleted.

The editable properties of express button may also include options that determine which program allows its screen view to be modified by adding an express button, and what act, e.g., among shaking, waving, and knocking, is designated as valid user input.

Turning to FIG. 7, which depicts an exemplary button window 32. The window may be arranged to show up on a screen when an express button or reappearing express button is activated. Compared to window 40 of FIG. 6-B, window 32 is more comprehensive with a longer list of options. The icons in window 32 represent not only selected applications, such as email, game, and chat, but also editing and other command functions. For instance, “Edit” icon may be used to change content and property of window 32, “Home” icon may lead to a home screen, “Standby” icon may cause the device to enter standby mode, and “Power off” icon may be used to shut down the device. When “Edit” icon is selected, another window may appear, where a user may change applications listed in window 32, the value of a time period during which window 32 lasts, or other contents and properties of the window. Again, window 32 may be set to appear only for a short period of time, and a user may close it anytime by tapping the “X” sign at the upper right corner.

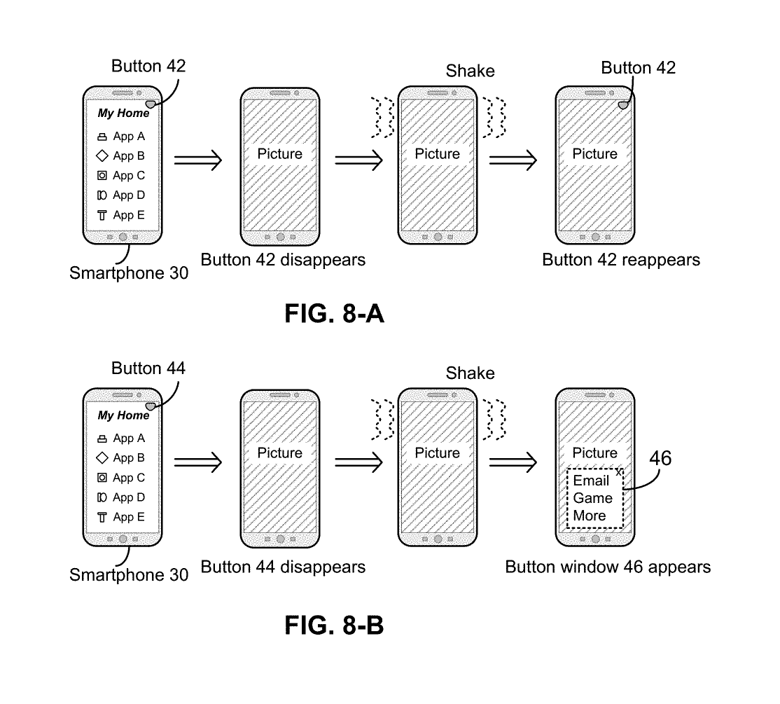

Another embodiment is illustrated using exemplary diagrams in FIG. 8-A. On a home screen of smart phone 30, an express button 42 is arranged for easy access of an application. When the phone runs some apps, like displaying photos or playing video clips, the whole screen may be used for presentation. Then button 42 may be removed from the screen and become invisible and inaccessible, as shown in the figure. To bring back button 42, a user may use tapping or hovering method, as discussed previously. But the tapping or hovering method requires a user to remember a particular spot on screen, and sometimes a target spot happens to contain interactive content, like an interactive icon or word, which makes it hard to do tapping. Thus it may not be convenient to get a button by tapping or hovering in some cases. For such a reason, another scheme is introduced in FIG. 8-A. After button 42 disappears from the screen, a user may shake phone 30. The shaking phenomenon may be detected by a sensor like sensor 24 of FIG. 1. Once phone 30 detects shaking signals, it is programed to let button 42 reappear for a given short period of time. During the short period when button 42 remains visible, a user may access a selected application by tapping on it. Aside from shaking, it may be designed such that signals of phone waving or knocking prompt reappearance of button 42 as well. Alternatively, the phone may also be arranged to take a user's verbal commands to show or remove a button. FIG. 8-B depicts a similar scheme. An express button 44, representing a button window 46, is arranged on the home screen of phone 30. Once the button is tapped, window 46 may appear with a list of applications. Assume that button 44 is obscured by a program. Shaking phone 30 may be arranged to make window 46 appear directly. Alternatively, if button 44 becomes invisible, shaking phone 30 may be designed to bring it back. When the button is tapped, window 46 shows up. Again the shaking act may be replaced by waving, knocking, or verbal instructions for making a button window show up.

### Conclusion, Ramifications, and Scope

Thus it can be seen that systems and methods are introduced to access an application or contents directly or with ease and quickness.

The improved methods and systems have the following features and advantages:
(1). An application or contents may be accessed directly from a locked state using password plus another element;
(2). An application or contents may be accessed directly via an express button;
(3). A list of applications may be accessed easily via an express button;
(4). Tapping, hovering, shaking, waving, or knocking act may make an express button appear or reappear temporarily;
(5). Tapping or hovering act may make an express button disappear; and
(6). Tapping or hovering act may make an express button appear, disappear, reappear, disappear at will.

Although the description above contains many specificities, these should not be construed as limiting the scope of the invention but as merely providing illustrations of some of the presently preferred embodiments. Numerous modifications will be obvious to those skilled in the art.

### Ramifications:

Some examples use a smartphone to describe embodiments. But as mentioned previously, embodiments introduced apply to other electronic devices as well, such as all kinds of computers, all kinds of wireless or wearable devices with computing and presentation functions.

In many embodiments described, tapping is singled out as the main method to enter input or interact with a device. Although tapping is convenient and effective when a screen is touch sensitive, clicking may also be used when computer mouse or touch pad is available.

A proximity sensor, when combined with other sensors, may be used to detect whether a device is shaking in hand, or shaking with something other than hand. And it may be configured so that only shaking in hand is taken as user input. The same rule may apply to waving act.

Many schemes discussed may be implemented using voice and mature speech recognition method. For instance, a user may say a password plus another element to unlock a device and launch a selected application. Or a user may say a password plus a code to invoke one among a group of applications. The voice activated method is especially useful when it is not convenient to use finger or both hands.

Furthermore, a device may be equipped with a facial recognition system. The system may at least recognize a device owner, which may protect a user's privacy by not following other people's instructions, or may be used to reset a selected app automatically for a specific user. The system may make use of detector like sensor 10 of FIG. 1 and employ facial recognition algorithms to identify people.

Eye-tracking technology may also be utilized. It may be designed such that when a shaking, waving, or knocking act happens, an eye-tracking sensor starts working. If it is detected that a user is watching the screen, shaking, waving, or knocking signals are taken as user commands. If the user is not watching the screen, the signals may be ignored.

With the discussion around FIGS. 6-A, 6-B, 8-A, and 8-B, it is noted that an express button may be turned on and off many times. For instance, a button may appear when a spot is tapped, vanish when a fingertip hovers above it, reappear when device shaking happens, vanish again when it is tapped twice, and then show up again when hovering act occurs. The three turn-on methods mentioned have the same effect and are exchangeable, so are the two turn-off schemes. Another example may look like this: Tapping on a screen spot to make a button appear, tapping twice to make the button disappear, tapping on the spot to make it appear again, tapping twice to make it disappear again, tapping on the spot to make it appear one more time, and finally tapping on the button once to launch an app. Thus it is up to a user, who may display an express button and gain easy access to a selected application or choose not to show it on screen.

In afore-mentioned examples, an express button may show up on home screen or in some programs automatically. However, the button may also be arranged to appear only when a user wants it to. For instance, it may be designed such that an express button only shows up when a user taps on a designated area, do finger-hovering above a designated area, shake a device, wave a device, knock a device, or give verbal commands. Without such a tapping, hovering, shaking, waving, knocking, or verbal act, the button may remain invisible. And once it appears, the button only appears for a given short period of time, like one to five seconds, before disappearing or leaving the screen by itself. When an appearing button is tapped or activated, a selected program may be invoked, or a button window may pop up with more options. As mentioned before, a button window may include multiple applications, and short-cuts to window property editing or device commands like standby or power off. It may also be designed such that one tap on button may activate it and two consecutive taps may make it disappear from screen. This embodiment, where a button remains invisible until being called, may be desirable for devices with a small screen, as any button or icon takes screen space and may make a screen look crammed.

It may also be designed such that tapping an express button once or twice opens up or invokes an app, and tapping the button three times or more makes it disappear. It may work for some users, since a shaking hand or finger may tap it twice inadvertently even though the intention is to tap it only once. Again, taping twice and more times are assumed to happen within a short period of time, say less than one or two seconds.

An express button may also be arranged to work as a home button or home key. Once the express button is activated, a home screen may show up. With such a arrangement, a hard or physical home button may no longer be needed, which may be desirable for small or tiny devices like wearable gadgets.

In addition, the shaking and knocking act as aforementioned may be used to wake up a device from power-off or standby state. For instance, it may be designed such that a low-power sensor system containing accelerometer is in operational mode during power off and standby period. The sensor may be used to detect device movement caused by shaking or knocks which represent another kind of shaking or vibration phenomenon. To avoid unnecessary response to natural shaking events, such as device shaking in a running car, signals are taken after a detected action stops. For instance, when a shaking event continues or doesn't stop, shaking signals are not taken as commands. Besides, when a shaking event lasts longer than a given value, say two to five seconds, the event is ignored. The qualification method for shaking signals applies to other schemes which take a shaking act as commands in other sections, as well as schemes using waving or knocking act in other sections. Once qualified signals are received, a power-on button may be arranged to show up on screen if the device is off, or a screen view of standby interface may appear for a standby device. With such schemes, a hard button designated for power on/off may be eliminated from the device body, as the power off function may also be provided via soft button on screen, as shown in FIG. 7. For instance, a user may lightly knock a device in power-off mode. After the device receives knocking signals, it may activate a touch-sensitive screen and show a “Power-On” button. Then, the user may tap on the button to turn on the device. Similarly, a user may shake a standby device a bit. In response, the device may light up a screen and display a standby interface. Thus, power-on from off state or wakeup from standby state may be completed using a sensor system and touch-sensitive screen only. Therefore, a hard button for power on/off may be replaced by soft button. Elimination of hard power on/off button may benefit some devices with small dimensions, where the surface area is limited and it becomes difficult to arrange buttons. The scheme may also benefit some portable or wearable devices which feature a thin body and whose screen may be designed to take as much space as possible for easy viewing.

Furthermore, once a device is turned on or waked up via a touch-sensitive screen, other functionality may be accessed via the screen as well. For instance, a soft home button is already introduced, as in FIG. 7, and the sound volume may be controlled via a soft button too. Some frequently-used functionality like sound volume control may be configured as a soft button or bar shown on home screen, like arranged near the upper left edge of screen. When a home screen is replaced by a screen view of an application, the volume control button or bar may become invisible. However, a volume control button or bar may be arranged to have the property of express button, i.e., it may be arranged to reappear automatically when tapping or fingertip hovering happens at the place where it occupies on a home screen. Thus when a voice control button is not visible, a user may tap on or make a finger hover over, for example, the upper left edge area of the screen, which may cause the button to appear. The appearing button may show up for a given short time during which the user may use it to adjust sound volume. In such a manner, soft buttons, including a volume control button, as well as a home button and a power off button, may be configured as accessible as a hard button, whether being visible or not. Therefore, hard buttons of a device may be replaced by soft buttons or a touch sensitive screen which supports soft buttons, and resultantly a device may be designed with no hard button at all. Without the burden to bear any hard button, it may help make small-sized gadgets and design devices which use most surface area to accommodate a display screen.

To make a screen neat and orderly, especially for a screen of a small gadget, often-used soft buttons like volume control, home button, and power-off may be configured invisible in screen views of all programs including a home screen until being called. The soft buttons may be arranged to appear for a given short time like two to five seconds when shaking, waving, or knocking happens, a button place is tapped, or a finger hovers over a button place. A user may engage with a soft button by adjusting it or tapping on it. It may be designed that the often-used buttons each stay at a fixed place on a screen. After shaking, waving, or knocking occurs, all often-used buttons appear briefly at own places. Thus a user may have a chance to choose a button and activate it. The brief button show also helps a user get familiar with button locations. Once the buttons' whereabouts are known, a user may use tapping or hovering act to reach a button individually.

Lastly, verbal instructions may be used to wake up a device from off or standby state and then do other chores, which may also help create devices free of hard buttons. For instance, a low-power voice-recognition system may remain on during power off period of a device. After a user says “power on”, the system may take the message and convert it into commands. Then a touch-sensitive screen is switched on and a “Power On” button or icon may show up on the screen. Next the user may tap the button or icon to turn on the device. Alternatively, a message “Power on?” may appear on screen, after a user says “power on”. Then the user may say “yes” to switch the device on. Therefore, voice recognition technology may provide another way to create devices without hard power-on button. Furthermore, devices without any hard button may be created as well, when voice recognition technology is combined with afore-discussed soft buttons.

Therefore the scope of the invention should be determined by the appended claims and their legal equivalents, rather than by the examples given.

1. A computer-implemented method for an unlocking or login process and presenting contents after the unlocking or login process at an electronic device, comprising:
a) presenting a screen view on a display of the electronic device for a user to enter a password;
b) providing a plurality of options for the user to select, the options provided via the screen view on the display; and
c) presenting the contents on the display after one of the options is selected by the user and the password is verified, the selected option related to the contents.

2. The method according to claim 1 wherein at least one option is presented on the display.

3. The method according to claim 1, further including opening a web page based on the selected option when the password is verified.

4. The method according to claim 1, further including disarming a security system when the password is verified.

5. The method according to claim 1, further including implementing a task based on the selected option when the password is verified.

6. The method according to claim 1 wherein the selected option and the password are entered respectively.

7. The method according to claim 1 wherein the options each are represented by at least one element among a plurality of elements, the elements include a numerical number, a letter, a character, an image, a word, or a sign.

8. A computer-implemented method for an unlocking or login process and presenting contents after the unlocking or login process at an electronic device, comprising:
a) presenting a screen view on a display of the electronic device for a user to enter a password;
b) providing a plurality of elements via the screen view for the user to select, the elements including a numerical number, a letter, a character, an image, a word, or a sign; and
c) presenting the contents on the display after at least one of the elements is selected by the user and the password is verified, the at least one of the elements representing a selected option among a plurality of options, the selected option related to the contents.

9. The method according to claim 8 wherein at least one option is presented on the display.

10. The method according to claim 8, further including opening a web page based on the selected option when the password is verified.

11. The method according to claim 8, further including disarming a security system when the password is verified.

12. The method according to claim 8, further including implementing a task based on the selected option when the password is verified.

13. The method according to claim 8 wherein the at least one of the elements and the password are entered respectively.

14. The method according to claim 8 wherein the selected option is represented by a single-digit number or at least one word.

15. A computer-implemented method for a login process and presenting a web page after the login process at an electronic device, comprising:
a) presenting a screen view on a display of the electronic device for a user to enter a password;
b) providing a plurality of options for the user to select, the options provided via the screen view on the display; and
c) presenting the web page on the display after one of the options is selected by the user and the password is verified, the selected option related to the web page.

16. The method according to claim 15 wherein at least one of the options is presented on the display.

17. The method according to claim 15, further including presenting selected contents based on the selected option when the password is verified.

18. The method according to claim 15 wherein the selected option and the password are entered respectively.

19. The method according to claim 15 wherein the options each are represented by at least one element, the element includes a numerical number, a letter, a character, an image, a word, or a sign.

20. The method according to claim 19 wherein the selected option is represented by a single-digit number or at least one word.
